(19) United States
(12) Patent Application Publication
(10) Pub. No.: US 2006/0138892 A1
(43) Pub. Date: Jun. 29, 2006

(54) Rotor and winding method of same

(75) Inventors: Mitsuaki Hagino, Yonago-shi (JP); Haruyuki Nakamoto, Yonago-shi (JP)

Correspondence Address: FOLEY AND LARDNER LLP;SUITE 500, 3000 K STREET NW, WASHINGTON, DC, 20007, US

(73) Assignees: MINEBEA MATSUSHITA MOTOR CO., LTD; MATSUSHITA ELECTRIC INDUSTRIAL CO., LTD.

(21) Appl. No.: 11/262,913

(22) Filed: Nov. 1, 2005

(30) Foreign Application Priority Data
Dec. 24, 2004 (JP) 2004-374309

(51) Int. Cl. H02K 23/26; H02K 3/00; H01R 39/32; H02K 1/00

(52) U.S. Cl. 310/198; 310/234; 310/196

(57) ABSTRACT

A rotor in which a crossover portion from a commutator riser to a salient pole portion is disposed so as not to be broken, and a winding method of the rotor are provided. In a rotor having: an armature core to which a shaft is fitted and fixed, and which has a plurality of salient pole portions; and a coil in which a winding wire is continuously wound around each of the salient pole portions, a crossover portion of the continuously wound winding wire to the coil is wound around the shaft in one or more turns. Preferably, the crossover portion is wound in 1.5 turns around the shaft. This is applicable also to a crossover portion other than the initial one

This application is based on Japanese Patent application JP 2004-374309, filed Dec. 24, 2004, the entire content of which is hereby incorporated by reference. This claim for priority benefit is being filed concurrently with the filing of this application.

### BACKGROUND OF THE INVENTION

1. Technical Field of the Invention

The present invention relates to a rotor of a general rotating machine and a winding method of the same, and more particularly to a rotor of a three-pole core DC motor having commutator risers and a winding method of the same.

2. Description of the Related Art

In the field of a rotating machine, the number of turns of a winding wire is increasing and the lamination factor is expanding. Therefore, a very thin conductor is employed as a conductor of a winding wire of a rotor. As the material of such a conductor, usually, tough pitch copper (TPC), oxygen-free copper (OFC), or the like is used. These materials are low in strength, and hence easily broken during a winding process. A Cu—Au (copper-gold) alloy conductor is excellent in strength and conductivity, but has problems in cost and productivity. Because of a practical reason, a copper alloy containing several wt. % of Ag (silver) which is excellent in stretch and winding properties is proposed.

Even when these winding conductors are used, an increased number of turns causes collapse of a winding wire, loosening of a winding wire, or the like under a conventional tension value. As a countermeasure, the tension pressure is increased, so that the winding shape is improved. However, tension breakage of a crossover portion (see, JP-A-1-222645) is induced.

In a production step of a rotor which is a component of a three-pole core DC motor, in a conventional winding method, a starting end of a copper wire is connected to a first commutator riser, and the copper wire is wound around a first core of a salient pole portion at the corresponding position. At this time, the wire is led so as to pass across a winding area of a third core of the salient pole portion.

FIGS. 2A and 2B are diagrams showing a conventional method of winding a rotor. FIG. 2A is a development view showing a connection state of a winding wire, and FIG. 2B is a production step diagram showing a procedure of a winding process. In the figures, the winding direction is denoted by an arrow.

An armature core (rotor core) 2 of a rotor 1 is configured by stacking punched magnetic steel plates, and has: an annular portion 3 having a through hole at the center; and three salient pole portions 4 which are radially projected from the annular portion 3. The salient pole portions 4 are formed as first to third cores arranged in one direction at regular intervals around an axis. A commutator 6 and commutator risers 7 are coupled and fixed with each other by a method such as the insert molding of a resin, thereby forming a commutator holder 5. A shaft 8 is fitted into an opening formed at the middle of the commutator holder 5.

The winding direction is set leftward in FIG. 2A. FIG. 2A shows placement relationships of a commutator risers (R1, R2, R3) and a salient pole portion (P1, P2, P3) which are numbered in the sequence of windings. The whole (the commutator risers and the salient pole portion) is placed so that, when the angular position around the shaft 8 is considered, the first commutator riser (R1) is positioned between the second core (P2) and the third core (P3) of the salient pole portion 4.

In this state, as shown in FIG. 2A, a starting end 9 of a winding wire 10 is wound in several turns around the first commutator riser (R1), and then linearly led out to be wound around the first core (P1) of the salient pole portion 4, and the winding wire is led out to the second commutator riser (R2) to be wound therearound (see, (1) of FIG. 2B). Thereafter, as shown in FIG. 2A, the winding wire 10 is led out from the second commutator riser (R2), wound in predetermined turns around the second core (P2) of the salient pole portion 4, and led out to the third commutator riser (R3) to be wound therearound (see (2) of FIG. 2B). Next, as shown in FIG. 2A, the winding wire 10 led out from the third commutator riser (R3) is wound in predetermined turns around the third core (P3) of the salient pole portion 4, and wound around the first commutator riser (R1) (see (3) of FIG. 2B). When the winding wire 10 is wound around the third core (P3), the winding process is conducted overlappingly on the winding wire 10 which is linearly led out from the first commutator riser (R1) at the beginning of the winding process. The winding wire 10 which is linearly led out at the beginning of the winding process is bent during the overlapping winding process.

The winding wire 10 wound around the salient pole portion 4 constitutes a coil 11. The winding wire 10 hanging between the commutator risers 7 and the salient pole portion 4 is indicated as a crossover portion 12.

When the winding process is conducted on the last core of the salient pole portion or the third core, therefore, the copper wire which is being stacked presses gradually the crossover portion hanging to the first core of the salient pole portion, and gives stress to the wire between the first core and the connecting portion of the commutator riser. As a result, a breakage fault that an edge portion of the commutator riser breaks the copper wire (see A of (3) of FIG. 2B) may be caused.

In a machine having a high lamination factor, particularly, the tension pressure of the winding wire is raised, and hence the wire breakage phenomenon remarkably appears.

In the initial stage of the winding process, the winding wire is linearly connected to the commutator riser by a short distance, and hence stress which is applied to the winding wire acts directly on the connecting portion. After the connection, therefore, wire breakage easily occurs in the connecting portion. In order to eliminate this phenomenon, a crossover portion may be loosely connected. However, the crossover portion is not stabilized, and the wire connecting work is hardly conducted.

### SUMMARY OF THE INVENTION

It is an object of the invention to provide a rotor in which a crossover portion from a commutator riser to a salient pole portion is disposed so as not to be broken, and a winding method of the rotor.

(1). A rotor comprising:

a shaft disposed at a middle of the rotor;

an armature core that comprises an annular portion having an opening to which the shaft is fitted, and a salient pole portion;

a coil comprising a winding wire continuously wound around each of the salient pole portion; and

a commutator riser disposed above the salient pole portion, a part of the winding wire being wound around the commutator riser and connecting to the coil;

wherein a crossover portion of the winding wire hanging between the commutator riser and the coil is wound around the shaft in one or more turns.

(2). The rotor according to (1), wherein the rotor has plural pair of the salient pole portion and the commutator riser.

(3). The rotor according to (1) or (2), wherein the winding wire is wound around the salient pole portion, and then wound around the commutator riser corresponding to the salient pole portion.

(4). The rotor according to any one of (1) to (3), wherein a starting end of the winding wire is fixed to one of the commutator riser.

(5). The rotor according to (4), wherein the winding wire fixed to the one of the commutator riser is wound around the shaft one or more turns before wound around the salient pole portion corresponding to the commutator riser.

(6). A rotor comprising:

a shaft disposed at a middle of the rotor;

an armature core that comprises an annular portion having an opening to which the shaft is fitted, and first to n-th salient pole portions that are radially projected from the annular portion;

a coil comprising a winding wire continuously wound around each of the salient pole portions;

first to n-th commutator risers disposed above the salient pole portions, a part of the winding wire being wound around each of the commutator risers and connecting to the coil; and

a commutator to which each of the commutator risers is connected, wherein

the numbers of the salient pole portions and the commutator risers are serially set in a direction around the same axis, the first commutator riser is placed at an angular position around the axis between the (n-1)-th and n-th salient pole portions, the winding wire that is wound around the first commutator riser at the beginning of winding is wound around the shaft in 1.5 turns, and then wound around the first salient pole portion, and the winding wire is consecutively wound in series around the commutator riser and the salient pole portion which have the same number, and wherein

n is an arbitrary integer of 3 or more.

(7). A method of winding a rotor, which comprises:

a shaft disposed at a middle of the rotor;

an armature core that comprises an annular portion having an opening to which the shaft is fitted, and a salient pole portion;

a coil comprising a winding wire continuously wound around each of the salient pole portion; and

a commutator riser disposed above the salient pole portion, a part of the winding wire being wound around the commutator riser and connecting to the coil; the method comprising:

winding a crossover portion of the winding wire, which hangs between the commutator riser and the coil, around the shaft in one or more turns.

(8). The method according to (7), wherein the crossover portion wound around the shaft is an initial crossover portion hanging between the commutator riser and the coil.

(9). The method according to (8), wherein the rotor comprises:

the shaft;

the armature core that comprises the salient pole portion comprising first to n-th salient pole portions that are radially projected from the annular portion;

the coil;

the commutator riser comprising first to n-th commutator risers that are connected to the coil; and

a commutator that is connected to the commutator risers, and wherein n is an arbitrary integer of 3 or more,

the method comprising:

setting the numbers of the salient pole portions and the commutator risers serially in a direction around the same axis,

placing the first commutator riser at an angular position around the axis between the (n-1)-th and n-th salient pole portions,

winding the winding wire that is wound around the first commutator riser at the beginning of winding, around the shaft in 1.5 turns, and then winding around the first salient pole portion, and

winding the winding wire consecutively in series around the commutator riser and the salient pole portion which have the same number.

According to the invention, the crossover portion can be prevented from being broken.

In the continuous winding, particularly, when a crossover portion from an initial commutator riser to an initial coil is wound around the shaft in one or more turns, the initial crossover portion can be prevented from being broken by later overlapping winding.

In a winding method of a rotor, it is possible to attain the wire breakage preventing function unique to a rotor having this configuration.

### BRIEF DESCRIPTION OF THE DRAWINGS

FIG. 1 is a diagram showing the winding method of a rotor according to one embodiment of the invention.

FIG. 2 is a diagram showing a conventional winding method of a rotor.

### DETAILED DESCRIPTION OF THE INVENTION

The invention is characterized in that a crossover portion of a winding wire is wound in one or more turns around a shaft. It is preferable that an initial crossover portion at the beginning of the winding wire is wound in one or more turns around the shaft. This characteristic is applicable also to a case where the numbers of salient pole portions and commutator risers are an arbitrary number of 3 or more.

In the winding method of the invention, the starting end is connected to a first commutator riser, wound around the shaft in a right or left hand direction in one or more or an arbitrary number of turns, and thereafter wound around a first core of the salient pole portion.

Since the crossover portion to the first core is wound around the shaft, the crossover portion can maintain the state where it is in close contact with the shaft and the core, and is not a crossover portion which passes across a winding area for a core other than the first core of the salient pole portion. Also when a winding wire is wound around an arbitrary core other than the first core, therefore, the application of stress to the crossover portion of the first core can be eliminated.

In addition to the initial crossover portion of the series winding, a crossover portion between a commutator riser and a coil wound around a salient pole portion may be wound in one or more turns around the shaft.

An embodiment of the invention will be described in detail with reference to the figures.

### Embodiment

The invention is realized in the case where the numbers (n) of the salient pole portions and the commutator risers are 3 or more. In the case, an embodiment can be configured.

For the sake of convenience in description, an embodiment in which the numbers n are 3 will be described.

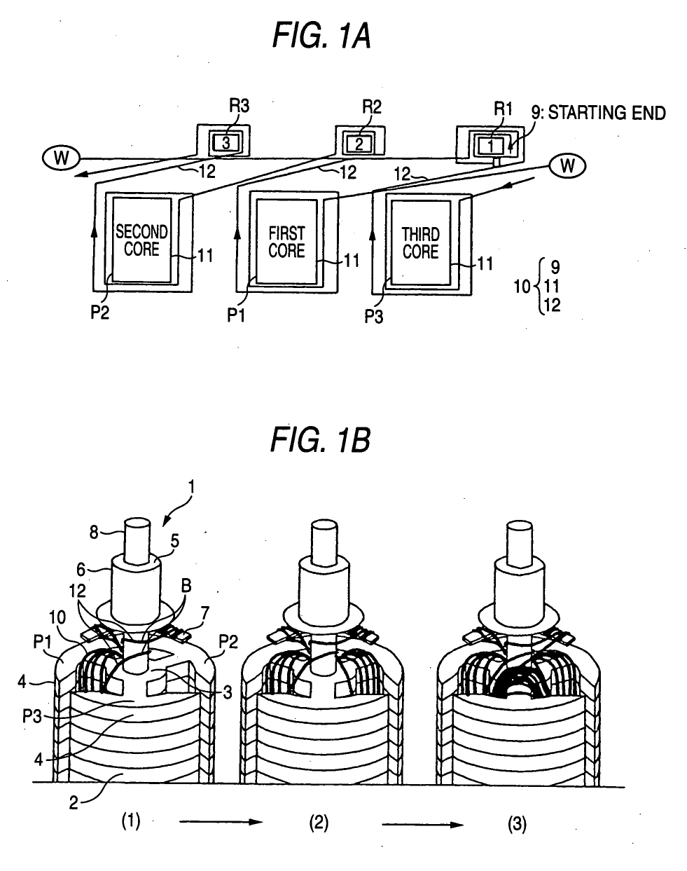

FIGS. 1A and 1B are diagrams showing the winding method of a rotor according to one embodiment of the invention. FIG. 1A is a development view showing a connection state of a winding wire, and FIG. 1B is a production step diagram showing a procedure of a winding process. In the figures, the winding direction are denoted by an allow.

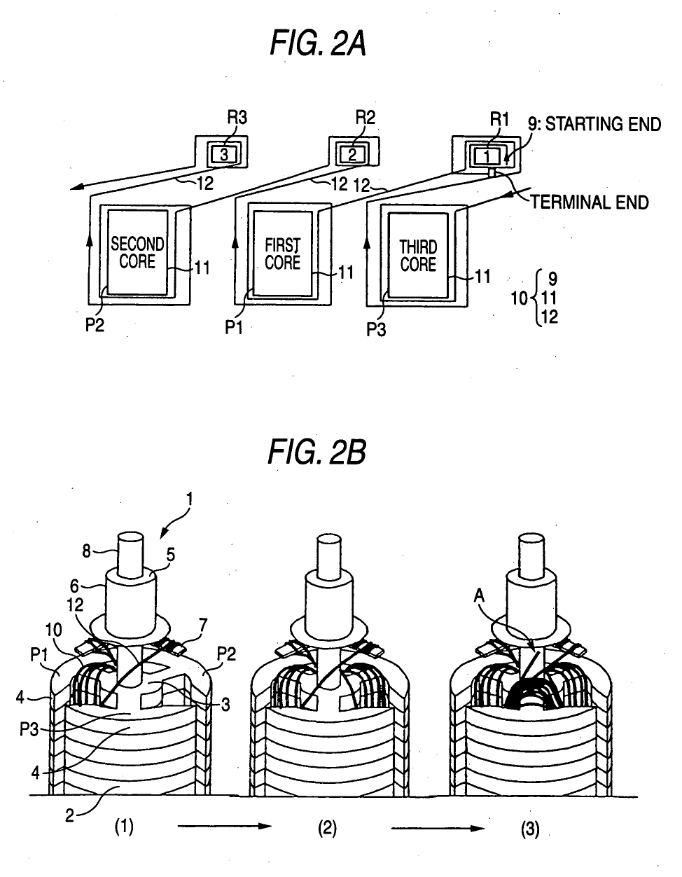

The configuration of a rotor 1 of FIG. 1 is identical with that of the conventional rotor of FIG. 2 except the winding method for a winding wire, and therefore the description of the common components described with reference to FIG. 2 will be omitted.

In the rotor 1 of FIG. 1, namely, an armature core (rotor core) 2 having an annular portion 3 and a salient pole portion 4, a commutator holder 5 comprising a commutator 6 and commutator risers 7 which are coupled with each other, and a shaft 8 are identical with those shown in FIG. 2. Their description will be omitted. In the case where a commutator base (not shown) exists between the commutator risers 7 and the armature core 2, crossover portions 12 are disposed in close contact with the base.

In this state, in accordance with the winding procedure shown in FIG. 1A, a starting end 9 of a winding wire 10 is wound in several turns around a first commutator riser (R1), then, wound around the shaft 8 from the first commutator riser (R1) in a right hand direction in 1.5 turns (see B in (1) of FIG. 1B), and thereafter wound around a first core (P1) of the salient pole portion 4 in a required number of turns.

At this time, the number of turns in which the winding wire 10 is wound around the shaft 8 is determined in accordance with placement relationships of the salient pole portion 4 and the commutator risers 7. The number is one or more, for example, one or more and ten or less, and preferably one or more and two or less. In the case where the salient pole portion 4 and the commutator risers 7 have placement relationships such as shown in FIGS. 1A and 1B, particularly, the number of turns is preferably set to 1.5 turns. When the minimum number of turns or one turn is ensured, the winding wire 10 is wound around the shaft 8, and the winding wire 10 led out from the commutator risers 7 does not protrude to the overlapping area of the salient pole portion 4. Therefore, the phenomenon that the winding is pulled as a result of overlapping does not occur. As a result, winding can be conducted in a relatively loose manner, and wire breakage can be prevented form occurring. As the number of turns in which the winding wire 10 is wound around the shaft 8 is increased more than one turn, or to two or more turns, the winding becomes unnecessary, and the loose winding is more hardly conducted.

Next, the winding wire 10 is led out from the first core (P1) of the salient pole portion 4 to the second commutator riser (R2) to be therearound (see (1) of FIG. 1B). Then, as shown in FIG. 1A, the winding wire 10 is led out from the second commutator riser (R2), wound around the second core (P2) of the salient pole portion 4 in a predetermined number of turns, and led out to the third commutator riser (P3) to be wound therearound (see (2) of FIG. 1B). Thereafter, as shown in FIG. 1A, the winding led out from the third commutator riser (R3) is wound around the third core (P3) of the salient pole portion 4 in a predetermined number of turns, and returned to the first commutator riser (R1) to be wound therearound (see (3) of FIG. 1B).

During the process of winding the winding wire 10 around the third core (P3), the winding wire 10 which is led out from the first commutator riser (R1) at the beginning of winding is wound in close contact with the peripheries of the shaft 8 and the cores of the salient pole portion 4. Therefore, the winding does not protrude into the winding region of the salient pole portion 4, and is not overlappingly wound thereon. Since the winding is wound around the shaft, the winding process can be conducted in a somewhat loose manner, and the wire is not broken even when the wire is pulled in some degree.

In addition to the above description, a crossover portion(s) between a commutator riser and a coil wound around a salient pole portion in addition to the initial crossover portion of the series winding may be wound around the shaft in one or more turns. In this case, the function and the effect are identical with those of the above-described embodiment.

In the above-described invention, the components can be modified as far as their functions are not changed.

What is claimed is:

1. A rotor comprising:
a shaft disposed at a middle of the rotor;
an armature core that comprises an annular portion having an opening to which the shaft is fitted, and a salient pole portion;
a coil comprising a winding wire continuously wound around each of the salient pole portion; and
a commutator riser disposed above the salient pole portion, a part of the winding wire being wound around the commutator riser and connecting to the coil;
wherein a crossover portion of the winding wire hanging between the commutator riser and the coil is wound around the shaft in one or more turns.

2. The rotor according to claim 1, wherein the rotor has plural pair of the salient pole portion and the commutator riser.

3. The rotor according to claim 2, wherein the winding wire is wound around the salient pole portion, and then wound around the commutator riser corresponding to the salient pole portion.

4. The rotor according to claim 3, wherein a starting end of the winding wire is fixed to one of the commutator riser.

5. The rotor according to claim 4, wherein the winding wire fixed to the one of the commutator riser is wound around the shaft one or more turns before wound around the salient pole portion corresponding to the commutator riser.

6. A rotor comprising:
a shaft disposed at a middle of the rotor;
an armature core that comprises an annular portion having an opening to which the shaft is fitted, and first to n-th salient pole portions that are radially projected from the annular portion;
a coil comprising a winding wire continuously wound around each of the salient pole portions;
first to n-th commutator risers disposed above the salient pole portions, a part of the winding wire being wound around each of the commutator risers and connecting to the coil; and
a commutator to which each of the commutator risers is connected, wherein
the numbers of the salient pole portions and the commutator risers are serially set in a direction around the same axis, the first commutator riser is placed at an angular position around the axis between the (n-1)-th and n-th salient pole portions, the winding wire that is wound around the first commutator riser at the beginning of winding is wound around the shaft in 1.5 turns, and then wound around the first salient pole portion, and the winding wire is consecutively wound in series around the commutator riser..and the salient pole portion which have the same number, and wherein
n is an arbitrary integer of 3 or more.

7. A method of winding a rotor, which comprises:
a shaft disposed at a middle of the rotor;
an armature core that comprises an annular portion having an opening to which the shaft is fitted, and a salient pole portion;
a coil comprising a winding wire continuously wound around each of the salient pole portion; and
a commutator riser disposed above the salient pole portion, a part of the winding wire being wound around the commutator riser and connecting to the coil; the method comprising:
winding a crossover portion of the winding wire, which hangs between the commutator riser and the coil, around the shaft in one or more turns.

8. The method according to claim 7, wherein the crossover portion wound around the shaft is an initial crossover portion hanging between the commutator riser and the coil.

9. The method according to claim 8, wherein the rotor-.cQmprises:.
the shaft;
the armature core that comprises the salient pole portion comprising first to n-th salient pole portions that are radially projected from the annular portion;
the coil;
the commutator riser comprising first to n-th commutator risers that are connected to the coil; and
a commutator that is connected to the commutator risers, and wherein n is an arbitrary integer of 3 or more,
the method comprising:
setting the numbers of the salient pole portions and the commutator risers serially in a direction around the same axis,
placing the first commutator riser at an angular position around the axis between the (n-1)-th and n-th salient pole portions,
winding the winding wire that is wound around the first commutator riser at the beginning of winding, around the shaft in 1.5 turns, and then winding around the first salient pole portion, and
winding the winding wire consecutively in series around the commutator riser and the salient pole portion which have the same number.
